(19) United States
(12) Patent Application Publication
(10) Pub. No.: US 2013/0034396 A1
(43) Pub. Date: Feb. 7, 2013

(54) DEBRIS COLLECTOR

(71) Applicant: August Joel Witthoeft, Centerville, MA (US)

(72) Inventor: August Joel Witthoeft, Centerville, MA (US)

(21) Appl. No.: 13/563,804

(22) Filed: Aug. 1, 2012

Related U.S. Application Data
(60) Provisional application No. 61/514,606, filed on Aug. 3, 2011.

(51) Int. Cl. B23B 47/00

(52) U.S. Cl. 408/67

(57) ABSTRACT

A debris collector for use with a hand or power cutting tool such as an electric drill has a conical body made of a foldable, flexible material. The conical body has an open upper base end and an open lower apex end. An upper support ring is secured to the conical body at the base end and a lower support ring is secured to the conical body spaced from the apex end.

### CROSS-REFERENCE TO RELATED APPLICATIONS

This application claims the benefit of U.S. Provisional Application No. 61/514,606 filed on Aug. 3, 2011. The entire disclosure of the above application is incorporated herein by reference.

### FIELD

The present disclosure relates to a debris collector that collects falling debris when a hand tool or hand-held power tool is used in cutting an overhanging structure, such as drilling a hole in a ceiling.

### BACKGROUND

This section provides background information related to the present disclosure which is not necessarily prior art.

Cutting overhanging structures, such as drilling holes in ceilings, is often done from below the overhanging structure. For example, when drilling holes in a ceiling with a hand-held electric drill, the drill is held by the user below the overhanging structure with the drill bit perpendicular to the overhanging structure. (It should be understood that perpendicular as that term is used in this context can include the drill bit being at slight angles to perpendicular.) The user energizes the drill and pushes it upwardly to move the drill bit into the overhanging structure as the drill bit rotates. As the drill bit rotates in the overhanging structure as the hole is being drilled, debris cut by the drill bit falls from the hole. For example, if a hole is being drilled in a drywall ceiling, plaster dust falls from the hole. If a hole is being drilled in wood, wood cuttings fall from the hole. This debris must then be cleaned up after the cutting operation. Also, since the user is often directly below the hole, the debris tends to fall on the user.

It is an object of this invention to provide a debris collector that collects falling debris from a hole that is being drilled in an overhanging structure.

### SUMMARY

This section provides a general summary of the disclosure, and is not a comprehensive disclosure of its full scope or all of its features.

A debris collector for use with a hand tool or hand-held power tool having a cutting tool has a conical body made of a foldable, flexible material. The conical body has an open upper base end and an open lower apex end. An upper support ring is secured to the conical body at the base end and a lower support ring is secured to the conical body spaced from the apex end.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side perspective view of a debris collector in accordance with an aspect of the present disclosure; and

FIG. 2 is a side perspective view of the debris collector of FIG. 1 being used with a drill.

Corresponding reference numerals indicate corresponding parts throughout the several views of the drawings.

### DETAILED DESCRIPTION

Example embodiments will now be described more fully with reference to the accompanying drawings.

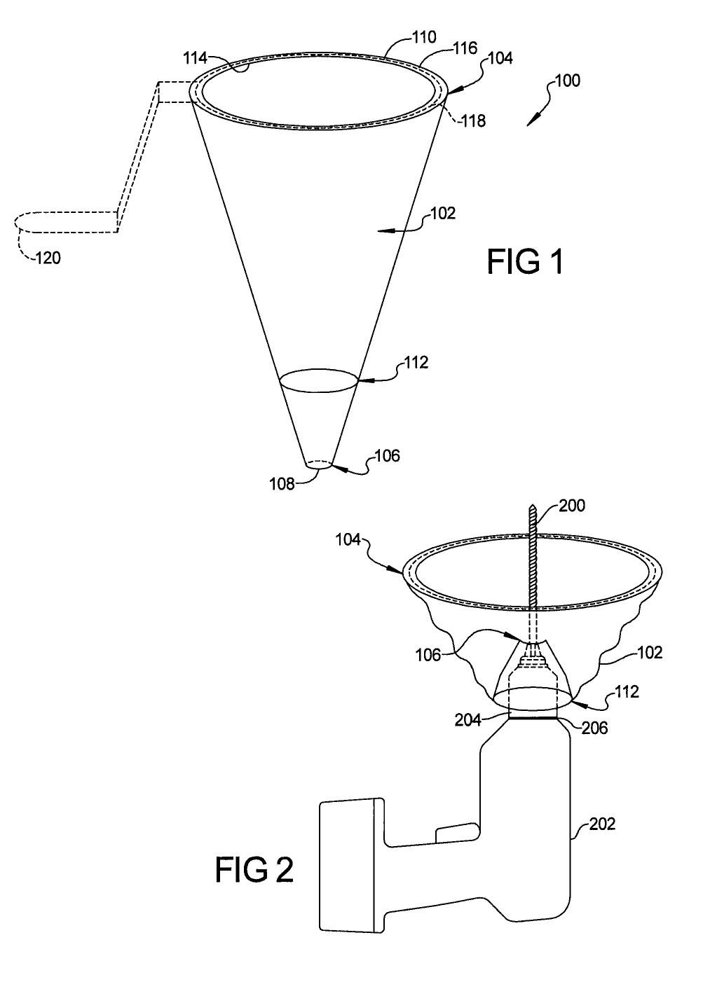

Referring to FIGS. 1 and 2, a debris collector 100 in accordance with an aspect of the present disclosure is shown. Debris collector 100 has a conical body 102 having an upper (as oriented in the drawings) base end 104 and a lower apex end 106. Base end 104 is open, designated as opening 114 in FIG. 1, as is lower apex end 106, designated as opening 108 in FIG. 1. Opening 108 of apex end 106 is sized to permit a cutting tool of a hand tool or hand-held power tool to fit through. Such a cutting tool may be a drill bit (such as drill bit 200 shown in FIG. 2), saw blade, router bit, or other known cutting tools of hand tools or hand-held power tools. The following description of debris collector 100 is in the context of a hand-held electric drill, but it should be understood that debris collector 100 can be used with other hand or power tools that have cutting tools, such as drywall saws by way of example and not of limitation.

In an illustrative embodiment, conical body 102 of debris collector 100 is made of a foldable, flexible material that easily folds on itself, such as a plastic used to make plastic bags (such as household garbage bags, sandwich bags, or the like). By way of example and not of limitation, this plastic material may be cast polypropylene having a thickness of 1.2 mm. In an aspect, this plastic is transparent, but it should be understood that it need not be transparent. The foldable, flexible material allows the apex end 106 of debris collector 100 to be easily pushed upwardly by a chuck 204 (in which drill bit 200 is held) of a hand-held electric drill 202 as drill 202 is pushed upwardly when drilling the hole in the overhanging structure.

Debris collector 100 also includes an upper support ring 110 secured to conical body 102 of debris collector 100 at base end 104 that surrounds opening 114. Upper support ring 110 may illustratively be a plastic ring. Debris collector 100 also includes a lower support ring 112 secured to conical body 102 of debris collector 100, illustratively on the outside of conical body 102. Lower support ring 112 may also be a plastic ring. The lower support ring 112 is spaced from apex end 106 and is sized to permit the appropriate portion of the hand tool or hand-held power tool to pass through, for example, chuck 204 of drill 202. Where the hand tool or hand-held power tool is drill 202, lower support ring has a diameter slightly greater than the diameter of chuck 204 of drill 202. While the embodiment shown in FIGS. 1 and 2 has upper support ring 110 and lower support ring 112, it should be understood that debris collector 100 could have additional support rings disposed between lower support ring 112 and upper support ring 110. Opening 114 in base end 104 is sufficiently large so that debris resulting from the cutting operation, such as drilling, falls into conical body 102 of debris collector 100 and debris collector 100 does not interfere with the cutting operation. By way of example and not of limitation, opening 114 and upper support ring 110 of a debris collector 100 for use with a hand-held electric drill (cordless or corded) may have a diameter of six inches, lower support ring 112 may have a diameter of two inches, and conical body 102 may have a height (when fully extended) of fourteen inches.

In operation, drill bit 200 of drill 202 is inserted through opening 108 in apex end 106 of conical body 102 of debris collector 100. Base end 104 of conical body 102 of debris collector 100 is held against a surface of the overhanging structure in which a hole is to be drilled by a user pushing upper support ring 110 up against the surface of the overhanging structure. The user energizes drill 202 and pushes drill 202 upwardly to drill the hole in the overhanging structure. As the drill 202 moves upwardly, chuck 204 of drill 202 pushes apex end 106 upwardly with conical body 102 folding or collapsing from apex end 106 up. As drill 202 is moved upwardly, a collar 206 of drill 202 then contacts conical body 102 of debris collector 100 at lower support ring 112 and begins pushing conical body 102 upwardly at lower support ring 112. Lower support ring 112 rides on collar 206 and prevents binding of conical body 102 with chuck 204 of drill 202. Drill bit 200 then contacts the surface of the overhanging structure in which the hole is being drilled and debris cut by drill bit 200 from the overhanging structure falls into conical body 102 of debris collector 100. After the user finishes drilling the hole, the user removes drill 202 from debris collector 100 and empties the contents of debris collector 100 into a trash receptacle.

An upper surface 116 of upper support ring 110 may have thereon a layer of low tack adhesive 118 to hold, or assist in holding, upper support ring 110 against the surface of the overhanging structure. Alternatively, or in addition, a handle 120, shown in phantom in FIG. 1, may be attached to upper support ring 110 that a user can grasp and use to push upper support ring 110 against the surface of the overhanging structure.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A debris collector for use with a hand or power tool, comprising:
a conical body made of a foldable, flexible material;
an open upper base end and a lower open apex end;
an upper support ring secured to the conical body at the base end; and
a lower support ring secured to the conical body spaced from the apex end.

2. The debris collector of claim 1 including a handle secured to the upper support ring.

3. The debris collector of claim 1 wherein an upper surface of the upper support ring has thereon a layer of low tack adhesive.

4. The debris collector of claim 1 wherein the hand or power tool is an electric drill having a chuck, the lower support ring having a diameter greater than the diameter of the chuck, wherein the lower support ring rides against a collar of the drill when the chuck of the drill has been pushed up through the open apex end.

5. The debris collector of claim 1 wherein the foldable, flexible material is a clear plastic material.

6. The debris collector of claim 5 wherein the foldable, flexible material is cast polypropylene.
